(19) United States
(12) Patent Application Publication
(10) Pub. No.: US 2009/0271699 A1
(43) Pub. Date: Oct. 29, 2009

(54) APPARATUS AND METHOD FOR UPDATING A REPORT THROUGH VIEW TIME INTERACTION

(75) Inventor: Geoffrey Neil PETERS, Vancouver (CA)

Correspondence Address: SAP Global IP c/o Cooley Godward Kronish LLP;William S. Galliani, 777 6th Street NW, Suite 1100, Washington, DC, 20001, US

(73) Assignee: Business Objects, S.A., Levallois-Perret (FR)

(21) Appl. No.: 12/111,135

(22) Filed: Apr. 28, 2008

(51) Int. Cl. G06F 17/24

(52) U.S. Cl. 715/255

(57) ABSTRACT

A computer readable storage medium includes executable instructions to open a report including a view time interaction module, to display structured report data provided to the view time interaction module, and to modify the structured report data in response to a call to the report initiated by the view time interaction module, where the call is based on update information generated by the view time interaction module in response to user input.

### FIELD OF THE INVENTION

The present invention relates generally to data retrieval and processing. More particularly, this invention relates to the updating of a report through view time interaction.

### BACKGROUND OF THE INVENTION

Business Intelligence (BI) generally refers to software tools used to improve business enterprise decision-making. These tools are commonly applied to financial, human resource, marketing, sales, service provider, customer, and supplier analyses. More specifically, these tools can include reporting and analysis tools for presenting information, content delivery infrastructure systems for delivering and managing reports and analytics, and data warehousing systems for cleansing and consolidating information from disparate sources. BI tools may work with data management systems, such as relational databases or On Line Analytic Processing (OLAP) systems used to collect, store, and manage raw data.

There are a number of commercially available BI products that produce reports from stored data, such as Crystal Reports™, BusinessObjects Voyager™, BusinessObjects Web Intelligence™, and BusinessObjects Enterprise™. As used herein, the term report refers to information automatically retrieved (i.e., in response to computer executable instructions invoked by a refresh or run command) from a data source (e.g., a database, a data warehouse, and the like), where the information is structured in accordance with a report schema that specifies the form in which the information should be presented. A non-report is an electronic document that is constructed without the automatic retrieval (i.e., in response to computer executable instructions) of information from a data source. Examples of non-report electronic documents include typical business application documents, such as a word processor document, a spreadsheet document, a presentation document, and the like.

A report document is generally created by a specialized tool including executable instructions to access and format data. A report document where the content does not include external data, either saved within the report or accessed live, is a template document for a report rather than a report document. Unlike other non-report documents that may optionally import external data within a document, a report document by design is primarily a medium for accessing, formatting, and presenting external data.

A report design tool contains executable instructions specifically designed to facilitate working with external data sources. In addition to instructions regarding external data source connection drivers, these instructions may include advanced filtering of data, instructions for combining data from different external data sources, instructions for updating join structures and relationships in report data, and instructions including logic to support a more complex internal data model (that may include additional constraints, relationships, and metadata).

In contrast to a spreadsheet type application, a report generation tool generally is not limited to a table structure but can support a range of structures. A report design tool is designed primarily to support imported external data, whereas a spreadsheet application equally facilitates manually entered data and imported data. In both cases, a spreadsheet application applies a spatial logic that is based on the table cell layout within the spreadsheet in order to interpret data and perform calculations on the data. In contrast, a report design tool is not limited to logic that is based on the display of the data, but rather can interpret the data and perform calculations based on the original (or a redefined) data structure and meaning of the imported data. Spreadsheet applications work within a looping calculation model, whereas report generation tools may support a range of calculation models. Although there may be an overlap in the function of a spreadsheet document and a report document, the applications used to generate these documents contain instructions with different assumptions concerning the existence of an external data source and different logical approaches to interpreting and manipulating imported data.

FIG. 1 illustrates a report 100 including a visualization module 104 for presenting report data 102, in accordance with the prior art. The report 100 provides report data 102 to the visualization module 104. The report data 102 is at least a portion of the structured data included in the report 100. The visualization module 104 displays the report data 102. The visualization module 104 is typically a previously generated graphical program that is subsequently integrated with the report 100, such as a Macromedia Flash™ object (.swf). The visualization module 104 can be inserted into and utilized by a range of platforms and host applications, and consequently can facilitate modular design of graphical display functionality of the report 100. The visualization module 104 can receive external input 103 from users of the report 100 However, the visualization module 104 is restricted to changing its view of the report data 102. The visualization module 104 does not initiate communication with the report 100 to enhance the user's ability to work with the report data 102.

It would be desirable to provide a BI solution that leverages the flexibility of previously generated graphical programs that can be subsequently integrated with a report to provide the capability to initiate communication with a report in response to user input to enhance the user's ability to work with structured report data.

### SUMMARY OF THE INVENTION

This invention includes a computer readable storage medium with executable instructions to open a report including a view time interaction module, to display structured report data provided to the view time interaction module, and to modify the structured report data in response to a call to the report initiated by the view time interaction module, where the call is based on update information generated by the view time interaction module in response to user input.

The invention also includes a computer readable storage medium with executable instructions to detect a first trigger, to generate first update information in response to the first trigger, and to initiate a call to a report, where the call is based on the first update information. The executable instructions to detect a first trigger, to generate first update information, and to initiate the call to the report are performed by a view time interaction module included in the report. Structured report data provided to the view time interaction module is modified in response to the call of the report.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates a report including a visualization module for presenting report data in accordance with the prior art;

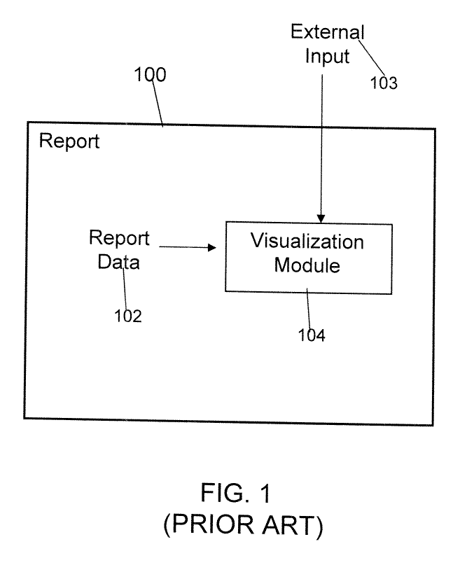

FIG. 2 illustrates a report including a view time interaction module, in accordance with one embodiment of the present invention;

FIG. 3 illustrates a system enabling view time interaction with a report, in accordance with one embodiment of the present invention;

FIG. 4 illustrates operations associated with user interaction with a report supporting view time interaction, in accordance with one embodiment of the present invention;

FIG. 5 illustrates operations associated with updating a report in response to triggering of view time interaction, in accordance with one embodiment of the present invention; and

FIG. 6 illustrates operations associated with updating a report viewer in response to triggering of view time interaction, in accordance with one embodiment of the present invention.

### DETAILED DESCRIPTION OF THE INVENTION

The invention is operative with a data source. A data source is an information resource. Data sources include sources of data that enable data storage and retrieval. Data sources may include databases, such as, relational, transactional, hierarchical, multidimensional (e.g., OLAP), object oriented databases, and the like. Further data sources may include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC) and the like. Data sources may also include a data source where the data is not stored like data streams, broadcast data, and the like.

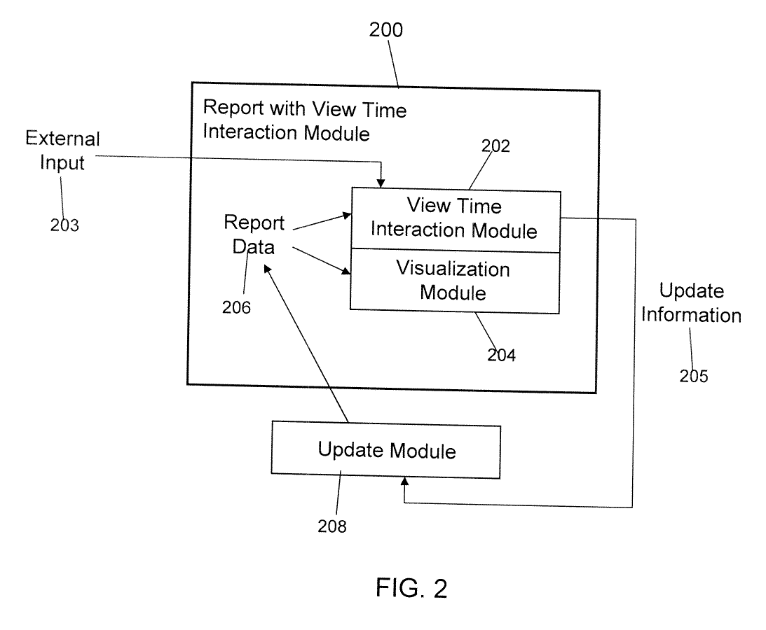

FIG. 2 illustrates a report 200 including a view time interaction module 202, in accordance with one embodiment of the present invention. The report 200 includes the view time interaction module 202 along with the visualization module 204. The visualization module 204 may be included within the view time interaction module 202. The view time interaction module 202 can be a previously generated graphical program that is subsequently integrated with the report 200, such as a Macromedia Flash™ object (.sw ).

The view time interaction module 202 generates update information 205 in response to detecting a trigger. The trigger may be based on an external input 203, or may be based on report data 206, which is at least a portion of the structured data included in the report 200. The external input 203 may be the result of direct user interaction, such as a user input to a grapical user interface module associated with the view time interaction module 202.

The view time interaction module 202 initiates a call to the report 200 based on the update information 205. The update information 205 can describe a modification of report data 206, which is structured data provided to the view time interaction module 202. The modification of report data 206 is a result of the call to the report 200 initiated by the view time interaction module 202. The call to the report 200 may update the report schema according to which the structured data included in the report 200 is formatted. In this case, the definition of the report 200 changes along with the modification of report data 206. Alternatively, the call to the report 200 may modify report data 206 without affecting the report schema. For example, the call to the report 200 may provide a parameter to the report 200, such as a date range, that the report 200 uses to filter the structured data included in the report 200 to obtain report data 206. The report 200 may also group, conditionally suppress, sort, summarize, or format structured data included in the report 200 to obtain report data 206.

In one embodiment, the call may provide the update information 205 to an update module 208 included in the report generator 322. The update module 208 calls the report 200 based on the update information 205.

The view time interaction module 202 then displays the report data 206. The display may be performed by the visualization module 204 included in the view time interaction module 202.

There are several benefits associated with using the view time interaction module 202 to initiate a call to the report 200 to modify structured report data provided to the view time interaction module 202. First, the report user's experience may be enhanced by this view time interaction, such as through a reduction in the number of commands that the user issues to a graphical user interface of the report 200. For example, a user may request to view summary performance metrics for a company such as revenues, profits, and operating margin for the four quarters of 2007. In response to this user request, the view time interaction module 202 may call the update module 208 with update information 205 including a description of related summary performance metrics by region and business segment for the four quarters of 2007 and a command to display those related metrics. The update module 208 then calls the report 200 based on the update information 205. This results in the report 200 providing the structured data representing the related metrics to the view time interaction module 202 and the display of the related metrics, without requiring additional user requests at report view time.

Second, the design of the report 200 may be facilitated by this view time interaction. For example, a complex feature such as user-defined multi-dimensional sorting has many possible combinations of sort parameters and sort orders. It may be difficult at design time to construct a report schema that supports all of these combinations in a manner that seems intuitive to a user of the report 200. However, additional flexibility may be available to the report designer because the view time interaction module 202 acts at view time to initiate a call to the report 200 that can result in a change to the definition of the report 200. For example, the view time interaction module 202 may include a custom sort control that specifies multiple dimensions, defines sort views, and switches between those sort views. The call to the report 200 can be based on update information 205 generated in response to user input to the custom sort control at report view time.

Third, this view time interaction can facilitate the design of a unified graphical user interface for the report 200. It is desirable to build this unified graphical user interface into the view time interaction module 202 to reduce or eliminate the need for a separate report viewer. This can focus the user's attention on the report 200, rather than having the user access menus and panels in the report viewer which are not directly tied to specific report content. For example, the user can specify filter parameters for structured data in the report 200 to modify report data 206 provided to the view time interaction module 202, so that the display of report data 206 is modified on-the-fly. In addition, the reduction or elimination of report viewer displays can free up more screen space for displaying the report 200, enhancing the presentation of structured report data to the user.

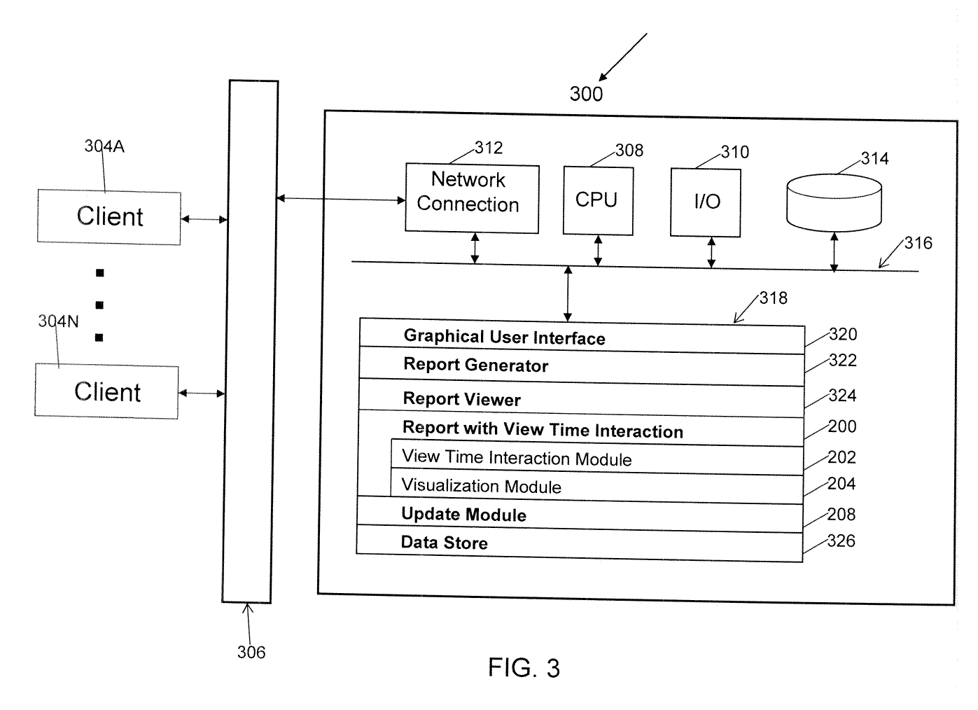

FIG. 3 illustrates a system 300 enabling view time interaction with the report 200, in accordance with one embodiment of the present invention. The system 300 includes a transmission channel 306 connecting a computer 302 with clients 304A-304N. The computer 302 includes standard components, such as a network connection 312, a CPU 308, input/output devices 310, and a data source 314, which communicate over a bus 316. A memory 318 is also connected to the bus 316. The memory 318 stores a set of executable programs that are used to implement functions of the invention. The clients 304 typically include the same standard components. The data source 314 may be internal and/or external to the computer 302. The data store module 326 may read data from and write data to memory 318 or to the data source 314.

In an embodiment of the invention, the memory 318 includes executable instructions establishing the various modules shown in FIG. 3. The graphical user interface module 320 allows the user to interact with the other modules contained in memory 318. For example, the graphical user interface module 320 may receive user input to the report generator 322 and the report viewer 324. The graphical user interface module 320 may also be integrated in the view time interaction module 202 to receive user input and to visualize report data 206. The report generator 322 can perform functions including the creation, design, refresh, and display of the report 200 with view time interaction. The report generator 322 also performs functions including accessing data and formatting data according to a report schema included in the report 200. The report generator 322 may access data stored in the data source 314 or the memory 318. After formatting of the retrieved data, the report generator 322 may store the formatted data in the data source 314 or the memory 318. The report viewer 324 enables the user to conveniently view the report 200, with features such as keyword searching and jump-to navigation. Via the report viewer 324, the user may view the report 200 and may also update parameters to perform on-the-fly filtering of data. The report viewer 324 may access data stored in the data source 314 or the memory 318. The report 200, the view time interaction module 202, the visualization module 204, and the update module 208 are as described in FIG. 2.

The modules in memory 318 are exemplary. The function of individual modules may be combined. In addition, the modules may reside on a single computer 302, or may be distributed across a network. For example, the report generator 322 and/or the report viewer 324 may reside on client 304. It is the processing associated with the invention that is significant, not where or how the processing is implemented.

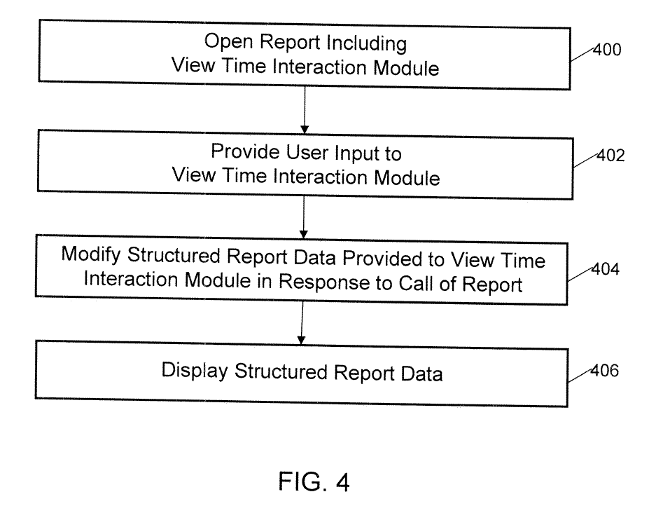

FIG. 4 illustrates operations associated with user interaction with a report 200 supporting view time interaction, in accordance with one embodiment of the present invention. A user opens the report 200 including the view time interaction module 202 (block 400). As part of opening the report, the report generator 322 and/or the report viewer 324 accesses data that is stored in data source 314 and/or memory 318. The user then provides input to the view time interaction module 202 (block 402). In this embodiment, the view time interaction module 202 is a previously generated graphical program that is subsequently integrated with the report 200, such as a Macromedia Flash™ object (.sw ). The user input may be provided to the graphical user interface module 320 associated with the view time interaction module 202.

The view time interaction module 202 initiates a call to the report 200 based on the update information 205 generated by the view time interaction module 202 in response to the user input, where report data 206 provided to the view time interaction module 202 is modified in response to the call of the report 200 (block 404). As described in the description of FIG. 2, the modification of report data 206 may occur along with a change to the definition of the report 200, such as an update to the report schema. Alternatively, the modification of report data 206 may occur without any change to the definition of the report 200, such as through filtering structured data included in the report 200.

The update information 205 can include a modification of input parameters to the report 200 such as facilitating user-defined filtering through, for example, a change to a date range or region for report data 206. A modification of input parameters to the report 200 may also enable showing or hiding a panel of the graphical user interface module 320 of the view time interaction module 202, navigating to a page of the report 200, and searching for a string within the report 200. Update information 205 can further include a modification of the definition of the report 200 such as for facilitating user-defined multi-dimensional sorting or user-defined drilldowns. Update information 205 can also include a command to apply the modification of the input parameters to the report 200, a command to apply the modification of the definition of the report 200, and a command to refresh report data 206.

In one embodiment, the view time interaction module 202 may initiate the call of the report 200 by providing the update information 205 to an update module 208 included in the report generator 322. The report generator 322 is an example of a container of the view time interaction module 202. The update module 208 calls the report 200 based on the update information 205. The update module 208 can include one or more event listeners that listen for a command from the view time interaction module 202, such as an external command call from a Macromedia Flash™ object (.swf). The list of commands from the view time interaction module 202 that are responded to by the update module 208 is customizable. The update module 208 can also include an application programming interface (API) that defines functions that can be called by the view time interaction module 202.

The view time interaction module 202 then displays report data 206 (block 406). The display of report data 206 may be performed by the visualization module 204 using the graphical user interface module 320, where both modules are associated with the view time interaction module 202.

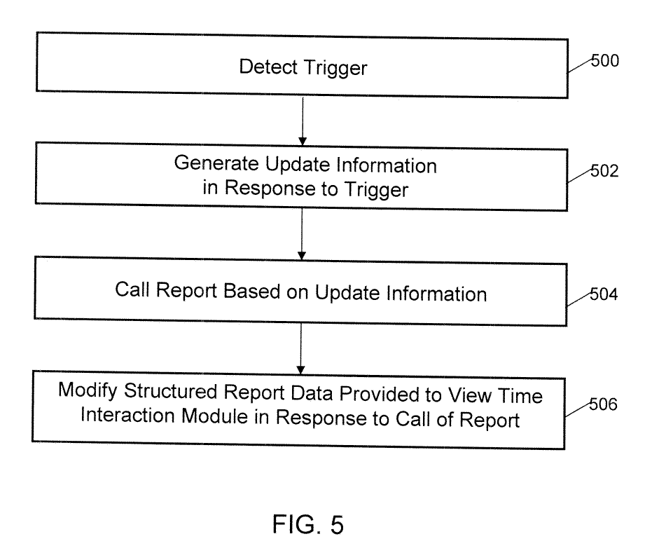

FIG. 5 illustrates operations associated with updating the report 200 in response to triggering of view time interaction, in accordance with one embodiment of the present invention. The view time interaction module 202 detects a trigger (block 500). The trigger may be a user input to the graphical user interface module 320 associated with the view time interaction module 202, or may be a change in report data 206. Update information 205 is then generated by the view time interaction module 202 in response to the trigger (block 502). The view time interaction module 202 then initiates a call to the report 200, where the call is based on the update information 205 (block 504). In one embodiment, the view time interaction module 202 may initiate the call of the report 200 by providing the update information 205 to an update module 208 associated with the report generator 322. The update module 208 calls the report 200 based on the update information 205. As described in FIG. 4, structured report data provided to the view time interaction module 202 is then modified in response to the call of the report 200 (block 506).

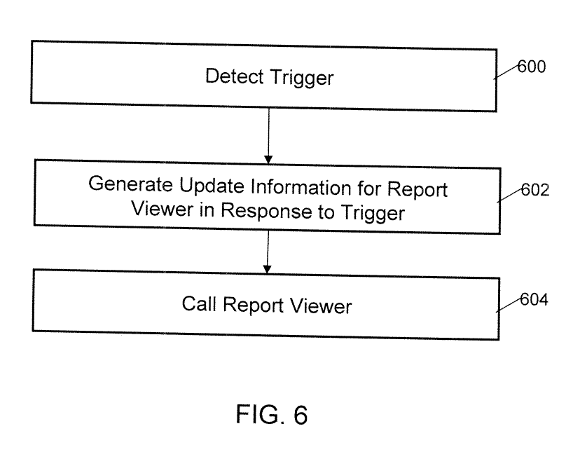

FIG. 6 illustrates operations associated with updating the report viewer 324 in response to triggering of view time interaction, in accordance with one embodiment of the present invention. The report viewer 324, like the report generator 322, may be associated with the report 200. The report viewer 324 may be included within a web browser. As described in FIG. 5, the view time interaction module 202 detects a trigger (block 600). Update information 205 is then generated by the view time interaction module 202 in response to the trigger (block 602). The update information 205 can include one or more commands to filter structured data included in the report 200, show or hide panels in the report viewer 324, jump to values in the report 200, and find text strings or values in the report 200. The view time interaction module 202 then calls the report viewer 324 (block 604). The report viewer 324 acts in response to the command specified by the update information 205.

An example of a workflow enabled by the operations of FIG. 6 includes the selection by the user of a dropdown menu item within the view time interaction module 202. Without further user action, this selection can result in the report viewer 324 navigating to a specific section of the report 200 and enabling a text search panel of the report viewer 324, as a result of the call to the report viewer 324 by the view time interaction module 202.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A computer readable storage medium, comprising executable instructions to:
open a report including a view time interaction module;
display structured report data provided to the view time interaction module; and
modify the structured report data in response to a call to the report initiated by the view time interaction module, wherein the call is based on update information generated by the view time interaction module in response to user input.

2. The computer readable storage medium of claim 1, wherein the executable instructions to display the structured report data include a graphical user interface module associated with the view time interaction module.

3. The computer readable storage medium of claim 2, wherein the update information includes at least one of a modification of input parameters to the report, a first command to apply the modification of the input parameters to the report, a modification of the definition of the report, a second command to apply the modification of the definition of the report, and a third command to refresh the structured report data.

4. The computer readable storage medium of claim 3, wherein the modification of the definition of the report enables at least one of user-defined sorting of the structured report data and user-defined drilldowns into the structured report data.

5. The computer readable storage medium of claim 3, wherein the modification of the input parameters to the report enables at least one of user-defined filtering to obtain the structured report data, showing a panel of the graphical user interface module, hiding a panel of the graphical user interface module, navigating to a page of the report, and searching for a string within the report.

6. The computer readable storage medium of claim 1, wherein the display of the structured report data is modified on-the-fly.

7. The computer readable storage medium of claim 1, wherein the call to the report is initiated by a call to a function defined in an application programming interface of a container of the view time interaction module.

8. A computer readable storage medium, comprising executable instructions to:
detect a first trigger;
generate first update information in response to the first trigger; and
initiate a call to a report, wherein the call is based on the first update information,
wherein the executable instructions to detect the first trigger, to generate first update information, and to initiate the call to the report are performed by a view time interaction module included in the report; and
wherein structured report data provided to the view time interaction module is modified in response to the call of the report.

9. The computer readable storage medium of claim 8, wherein the view time interaction module is a graphical program that is integrated with the report.

10. The computer readable storage medium of claim 8, wherein the structured report data is modified on-the-fly.

11. The computer readable storage medium of claim 8, wherein the view time interaction module includes a graphical user interface module for receiving a user input.

12. The computer readable storage medium of claim 11, wherein the first trigger is detected by the view time interaction module based on the user input to the graphical user interface module.

13. The computer readable storage medium of claim 8, wherein the first trigger is detected by the view time interaction module based on the structured report data.

14. The computer readable storage medium of claim 8, wherein the first update information is generated based on the user input.

15. The computer readable storage medium of claim 14, wherein the first update information includes at least one of a modification of input parameters to the report, a first command to apply the modification of the input parameters to the report, a modification of the definition of the report, a second command to apply the modification of the definition of the report, and a third command to refresh the structured report data.

16. The computer readable storage medium of claim 15, wherein the modification of the definition of the report enables at least one of user-defined sorting of the structured report data and user-defined drilldowns into the structured report data.

17. The computer readable storage medium of claim 15, wherein the modification of the input parameters to the report enables at least one of user-defined filtering to obtain the structured report data, showing a panel of the graphical user interface module, hiding a panel of the graphical user interface module, navigating to a page of the report, and searching for a string within the report.

18. The computer readable storage medium of claim 8, further comprising executable instructions to:
detect a second trigger;
generate second update information in response to the second trigger;
call a report viewer to provide the second update information to the report viewer; and
wherein the executable instructions to detect the second trigger, to generate second update information, and to call the report viewer are performed by the view time interaction module.

19. The computer readable storage medium of claim 18, wherein the report viewer is included in a web browser.

20. The computer readable storage medium of claim 18, wherein the second update information includes at least one of a first command to show a panel of the report viewer and a second command to hide a panel of the report viewer.
